(19) United States
(12) Patent Application Publication
(10) Pub. No.: US 2026/0259331 A1
(43) Pub. Date: Sep. 3, 2026

(54) LOW-COMPLEXITY FAST ACQUISITION TECHNIQUE WITH MINIMAL SNR LOSS

(71) Applicant: Samsung Electronics Co., Ltd., Gyeonggi-do (KR)

(72) Inventor: Ali MONTAZERI, San Jose, CA (US)

(21) Appl. No.: 19/354,256

(22) Filed: Oct. 9, 2025

Related U.S. Application Data
(60) Provisional application No. 63/765,299, filed on Feb. 28, 2025.

(51) Int. Cl. G01S 19/30; G01S 19/29; H04J 13/00

(52) U.S. Cl. CPC G01S 19/30; G01S 19/29; H04J 13/0062

(57) ABSTRACT

A method of acquiring a signal in a receiver is provided. The method includes: receiving a signal including a reference code; generating a plurality of frequency hypotheses across a Doppler frequency range associated with the signal; rotating the signal using a composite signal formed by summing time sections of sinusoidal tones corresponding to the plurality of frequency hypotheses; downsampling the rotated signal; applying a respective phase correction to the downsampled signal for each of the plurality of frequency hypotheses to produce a plurality of phase-corrected signals; correlating each phase-corrected signal with the reference code to detect the signal that includes the reference code and generate a plurality of correlation outputs; and selecting a frequency hypothesis of the plurality of frequency hypotheses and a code phase based on a maximum value among the correlation outputs.

### CROSS-REFERENCE TO RELATED APPLICATION

This application claims the priority benefit under 35 U.S.C. § 119(e) of U.S. Provisional Application No. 63/765,299, filed on Feb. 28, 2025, the disclosure of which is incorporated by reference in its entirety as if fully set forth herein.

### TECHNICAL FIELD

The disclosure generally relates to signal processing techniques in communication and navigation systems. More particularly, the subject matter disclosed herein relates to improvements to methods and systems for acquiring signals affected by Doppler shifts.

### SUMMARY

In wireless communication and satellite navigation systems, signal acquisition is a key step in which a receiver attempts to detect a transmitted signal and estimate parameters such as code phase and Doppler frequency shift. Doppler shifts arise due to relative motion between the transmitter and receiver, introducing a frequency offset that complicates acquisition. Certain acquisition methods involve generating and testing multiple frequency hypotheses by independently rotating the received signal for each hypothesis. This process can be computationally intensive and power consuming, particularly in real-time or low-power environments.

To address this, previous solutions apply individual frequency rotations to the received signal for each hypothesis and perform correlation with a known reference code to detect signal presence. Some implementations use parallel processing paths to evaluate multiple hypotheses simultaneously, while others employ Fast Fourier Transform (FFT)-based correlation or narrow the search-space using predictive constraints to improve efficiency.

One issue with the above approaches is the need to rotate the received signal separately for each frequency hypothesis at the full input sampling rate. This leads to repeated, high-rate processing, which increases computational burden and power consumption. These inefficiencies make such approaches less suitable for scalable, low-power receivers or systems requiring rapid acquisition under constrained conditions.

To overcome these issues, methods and systems are described herein for acquiring a signal by performing a single full-rate rotation of a received signal using a composite signal. The composite signal is formed by summing portions of sinusoidal tones corresponding to a plurality of Doppler frequency hypotheses. After this rotation, the resulting signal is passed through a correlator that correlates it with a reference signal, and the correlated signal is downsampled. Low-rate, per-hypothesis phase corrections are subsequently applied to the downsampled signal. Unlike methods that apply separate full-rate rotations for each hypothesis, the disclosed method reuses a common downsampled signal across all hypotheses, thereby significantly reducing computation. This approach enables to faster and more power-efficient acquisition without sacrificing detection accuracy (i.e., without signal-to-noise ratio (SNR) loss).

In an embodiment, a method of acquiring a signal in a receiver comprises: receiving a signal including a reference code; generating a plurality of frequency hypotheses across a Doppler frequency range associated with the signal; rotating the signal using a composite signal formed by summing time sections of sinusoidal tones corresponding to the plurality of frequency hypotheses; downsampling the rotated signal; applying a respective phase correction to the downsampled signal for each of the plurality of frequency hypotheses to produce a plurality of phase-corrected signals; correlating each phase-corrected signal with the reference code to detect the signal that includes the reference code and generate a plurality of correlation outputs; and selecting a frequency hypothesis of the plurality of frequency hypotheses and a code phase based on a maximum value among the correlation outputs.

In an embodiment, a user equipment (UE) comprises: a processor; and a non-transitory computer readable storage medium storing instructions that, when executed, cause the processor to: receive a signal including a reference code; generate a plurality of frequency hypotheses across a Doppler frequency range associated with the signal; rotate the signal using a composite signal formed by summing time sections of sinusoidal tones corresponding to the plurality of frequency hypotheses; downsample the rotated signal; apply a respective phase correction to the downsampled signal for each of the plurality of frequency hypotheses to produce a plurality of phase-corrected signals; correlate each phase-corrected signal with the reference code to detect the signal that includes the reference code and generate a plurality of correlation outputs; and select a frequency hypothesis of the plurality of frequency hypotheses and a code phase based on a maximum value among the correlation outputs.

In an embodiment, a method of acquiring a signal in a receiver comprises: rotating a received signal using a composite signal based on a plurality of Doppler frequency hypotheses; applying a respective phase correction to the rotated signal for each of the plurality of Doppler frequency hypotheses to generate a plurality of phase-corrected signals; and determining a Doppler frequency hypothesis associated with the received signal based on the phase-corrected signals.

### BRIEF DESCRIPTION OF THE DRAWINGS

In the following section, the aspects of the subject matter disclosed herein will be described with reference to exemplary embodiments illustrated in the figures, in which:

FIG. 1 illustrates an example transmission scenario in which relative motion between a transmitter and a receiver causes a received signal to experience a Doppler frequency shift;

FIG. 2 is a flowchart of a method of acquiring a signal in a receiver, according to an embodiment;

FIG. 3 is a block diagram of a receiver implementing a method of acquiring a signal, according to an embodiment;

FIG. 4 is a block diagram of an electronic device in a network environment, according to an embodiment; and

FIG. 5 shows a system including a UE and a gNB in communication with each other.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” may refer to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

“Reference code” as used herein may refer to a known sequence embedded in a transmitted signal that is used by a receiver for synchronization and acquisition. Some examples of “reference code” may include Pseudorandom Noise (PN) sequences and Zadoff-Chu sequences. “Frequency hypotheses” as used herein may refer to candidate Doppler frequency offsets tested by the receiver to compensate for unknown frequency shifts in the received signal. Some examples of “frequency hypotheses” may include frequency values spanning a Doppler search range, such as {−5 kHz, −4.5 kHz, . . . , 4.5 kHz, 5 kHz}. A “frequency offset” may refer to a difference between an expected or nominal signal frequency and the actual frequency of a received signal. Some examples of “frequency offset” may include a Doppler-induced shift caused by relative motion between a transmitter and a receiver, or a local oscillator mismatch between transmitting and receiving devices. “Composite signal” as used herein may refer to a signal formed by summing a plurality of sinusoidal tones, each corresponding to a different Doppler frequency hypothesis. Some examples of “composite signal” may include the sum of complex exponentials

$${\sum }_{i = 1}^{N} {e}^{j 2 π {f}_{i} n} ,$$

where each ﬁ is a frequency hypothesis used for rotating the received signal in a single operation. “Tones” as used herein may refer to sinusoidal signals associated with specific Doppler frequency hypotheses, expressed as complex exponentials. Some examples of “tones” may include e^{j2πf}^{ᵢ}ⁿ, where ﬁ is a particular frequency hypothesis and n is a discrete time index. “Sections of tones” may refer to portions or time segments of sinusoidal signals that correspond to specific Doppler frequency hypotheses. Some examples of “sections of tones” may include partial waveform intervals of complex exponentials used to form a composite signal, such as subsets of sinusoidal tones having frequencies within a Doppler search range that are summed together over time.

“Phase-corrected signals” as used herein may refer to versions of a downsampled received signal that has been adjusted in phase to compensate for residual phase offsets associated with specific Doppler frequency hypotheses. The downsampling may be performed after an initial composite rotation and correlation to reduce the sampling rate while preserving essential signal characteristics for acquisition. Some examples of downsampling methods include decimation using an integer factor aligned with an integration interval, averaging of accumulated samples, or clock-rate reduction controlled by a decimator circuit or digital filter. Some examples of “phase corrected signals” may include signals obtained by multiplying the downsampled signal with a complex exponential of the form e^{-jφi}, where φi corresponds to the residual phase for the ith hypothesis. “Correlation outputs” as used herein may refer to the results of comparing each phase-corrected signal with a known reference code to assess signal alignment and detect presence. Some examples of “correlation outputs” may include correlation magnitudes or energy values computed for each Doppler frequency hypothesis, indicating how well the received signal matches the expected code and timing. “Code phase” as used herein may refer to the timing offset between the received signal and a locally generated reference code, indicating where in the code sequence the received signal begins. Some examples of “code phase” may include a sample index at which peak correlation occurs during signal acquisition.

According to an embodiment of the disclosure, there is provided a method and system for acquiring a signal affected by Doppler shift using an efficient, shared-processing architecture. A received signal that includes a reference code may be first rotated using a composite signal formed by summing multiple tones, where each tone corresponds to a distinct Doppler frequency hypothesis. This single, full-rate rotation may eliminate the need to process each hypothesis individually at the input sampling rate.

After rotation, the signal may be downsampled to reduce computation. A respective phase correction may then be applied to the downsampled signal for each frequency hypothesis, and the corrected signals may be correlated with the reference code to detect signal presence. A Doppler frequency hypothesis and code phase may be selected based on the correlation outputs. This architecture may reuse the same downsampled signal across hypotheses and perform per-hypothesis adjustments at a lower rate, thereby enabling faster and more power-efficient signal acquisition.

The Doppler phenomenon may arise when there is relative motion between a transmitter and a receiver, causing the frequency of a transmitted signal to be perceived differently at the receiver. For example, in a satellite navigation system, a satellite continuously transmits a signal including a known reference code. As the satellite moves relative to the receiver on Earth, the received signal may experience a frequency shift, appearing slightly higher when the satellite approaches and slightly lower when it moves away. A similar effect may occur in terrestrial wireless communication systems when a user equipment (UE) moves relative to a base station (gNB). The resulting Doppler frequency offset may lead to a misalignment between the locally generated reference code in the receiver and the received signal, thereby complicating signal acquisition and synchronization unless multiple Doppler frequency hypotheses are tested to compensate for the unknown frequency shift.

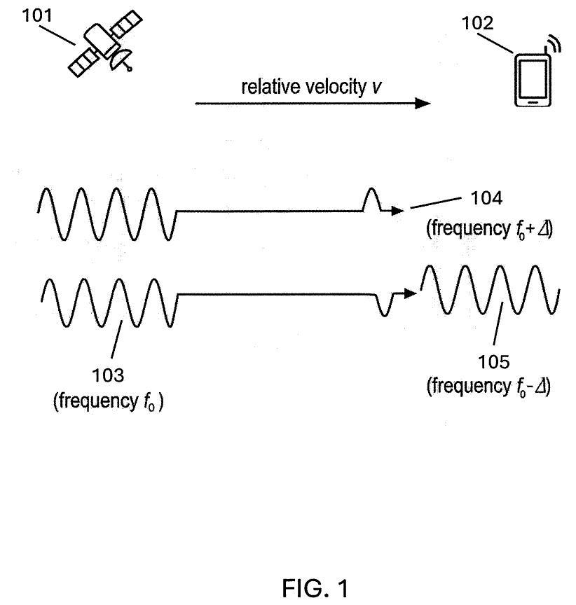

Before describing embodiments of the disclosed acquisition method, FIG. 1 illustrates an example transmission scenario in which relative motion between a transmitter and a receiver causes a received signal to experience a Doppler frequency shift.

Referring to FIG. 1, a transmitter 101 (e.g., a satellite or base station) may transmit an original signal 103 having a nominal frequency f₀ toward a receiver 102 (e.g., UE). When the transmitter 101 moves relative to the receiver 102, the received signal may undergo a frequency shift proportional to the relative velocity v between them. As illustrated by the arrow labeled “relative velocity v,” motion of the transmitter 101 toward the receiver 102 may produce a received signal 104 having an increased frequency (f₀+Δf), while motion of the transmitter 101 away from the receiver 102 may produce a received signal 105 having a decreased frequency (f₀−Δf). The shift Δf may represent the Doppler offset introduced by the relative motion and may result in a misalignment between the locally generated reference code in the receiver 102 and the received signal. The difference in frequency between the transmitted signal 103 and the received signals 104 and 105 may complicate signal acquisition, thereby requiring the receiver 102 to search across multiple Doppler frequency hypotheses to correctly align with the transmitted code sequence.

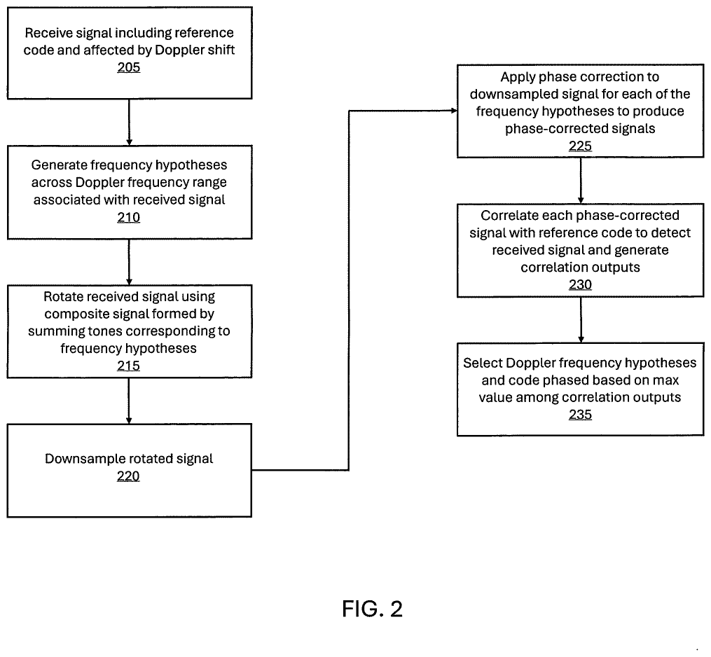

FIG. 2 is a flowchart of a method of acquiring a signal in a receiver, according to an embodiment.

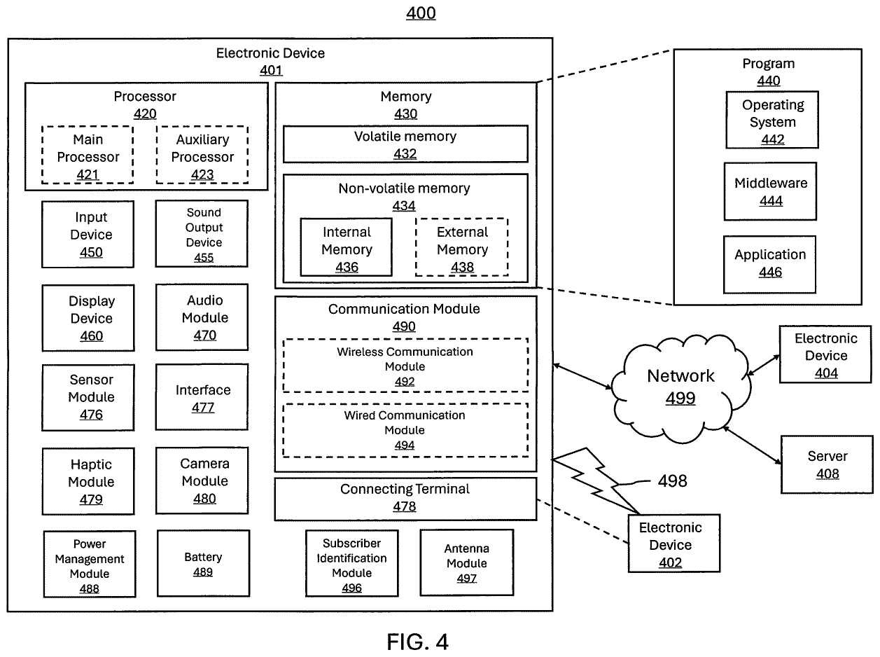

At step 205, a receiver may acquire a signal r[n], which represents an incoming transmission that includes a known reference code and is affected by Doppler shift. The received signal r[n] may be received from a remote transmitter such as a satellite, base station, or access point and is processed by the receiver after digitization and an optional downconversion. In the implementation shown in FIG. 4, the received signal may be captured by the antenna module 497, down-converted and digitized by the communication module 490, and then provided to the processor 420 for baseband processing. The known reference code may be a PN sequence, a Zadoff-Chu sequence, or another code used for synchronization and signal acquisition in wireless or satellite communication systems.

PN sequences may be useful in systems employing spread-spectrum or code-division-based signaling because they exhibit noise-like autocorrelation properties and low cross-correlation with other sequences. While other code types such as Zadoff-Chu sequences may provide constant amplitude properties, PN sequences can be implemented with simpler generation circuitry and are compatible with a wide range of low-power receivers.

The received signal r[n] may be expressed as:

$$r [ n ] = {s}_{K} [ N ] \cdot {e}^{( j 2 {πf}_{k} n + {ϕ}_{k} )} + w [ n ]$$

$${s}_{k} [ n ] {=}^{def} b \cdot {c}_{k} [ n - {τ}_{k} ] \cdot {d}_{k} [ n ]$$

where: |b|² is the signal power, c is the PN code of sequence k, τₖ and fₖ are time and frequency offsets,

$$w ∼ N ( 0 , {σ}_{w}^{2} )$$

is white Gaussian noise, fₖ is the unknown Doppler frequency shift, φₖ is an unknown phase offset, and w[n] represents additive noise (e.g., Gaussian noise). In this context, |b|² represents the signal power, which may denote a normalized power level of the discrete-time baseband signal r[n] or the received signal power in physical units such as watts at the receiver input.

The term e^{(j2πf}^{ₖ}^{n+φ}^{ₖ}⁾ is a complex sinusoid modeling the Doppler-induced frequency and phase distortion that may be due to motion between the transmitter and receiver. The frequency distortion appears as a shift in the received signal's frequency by an amount proportional to the Doppler frequency, while the phase distortion appears as a gradual change in the signal's phase over time due to variations in propagation path length. The input to this step is the complex digitized baseband signal, which refers to a sampled version of the received signal after downconversion to baseband. The signal is described as “complex” because it includes both in-phase (I) and quadrature (Q) components that represent the real and imaginary parts of the baseband waveform. The output of this step is the discrete-time signal r[n], which proceeds to the processing next stage for Doppler frequency hypothesis generation.

At step 210, the receiver may generate a plurality of Doppler frequency hypotheses to account for the unknown frequency offset fₖ present in the received signal r[n]. These hypotheses span a Doppler search range based on expected transmitter-receiver motion, oscillator mismatch, or other system-specific parameters, and may be generated by the processor 420 (e.g., its auxiliary processor 423) of the electronic device shown in FIG. 4.

Let the Doppler frequency range be defined by bounds of fmin and fmax, respectively, and let N denote the total number of discrete hypotheses to be tested. The Doppler frequency range may represent the expected limits of frequency offset that may occur between a transmitter and a receiver due to relative motion, oscillator mismatch, or other system-induced frequency deviations. The selection of this range may depend on parameters such as the operating carrier frequency, the maximum expected relative velocity between the transmitter and receiver, and the accuracy of local oscillators. For example, in a satellite navigation system operating near 1.5 GHz, the Doppler range may extend to ±5 kHz due to high orbital velocities, whereas in a terrestrial wireless communication system operating near 2.6 GHz, the range may be within ±1 kHz for typical user motion. In some embodiments, a larger range may be set to account for additional uncertainties such as oscillator drift or channel dynamics. The receiver constructs a set of frequency hypotheses:

$$F = \{ f 1 , f 2 , … , fN \}$$

where each ﬁ lies within the range [fmin, fmax]. The spacing between adjacent hypotheses may be selected by the desired frequency resolution, such as, 1/T, where T is the coherent integration time. The resulting hypotheses set F is used in the next step to construct a composite signal across all candidate frequency offsets in a single operation.

At step 215, the received signal r[n] may be rotated using a composite signal, which is formed by summing tones corresponding to the plurality of frequency hypotheses generated in step 210. This rotation may be performed by the processor 420 or by the communication module 490 of the electronic device shown in FIG. 4.

Rather than rotating the received signal r[n] separately for each hypothesis, which is a process that would require repeated high-rate complex multiplications, the method forms a single composite signal. The composite signal combines individual sinusoidal components (i.e., tones), each representing a distinct Doppler frequency hypothesis, into one aggregate signal. The composite signal may be generated by summing part of the complex sinusoidal waveforms corresponding to the candidate frequency offsets, or by precomputing and storing the result of such a summation.

The received signal r[n] may be multiplied with this composite signal in a single operation, producing a rotated signal that captures the frequency-translated components associated with all hypotheses. This one-time, full-rate rotation significantly reduces computational complexity and power consumption by avoiding separate per-hypothesis multiplications at the input sampling rate.

The output of this step, the rotated signal, may contain mixed frequency content aligned with all hypothesized Doppler shifts and is passed to the next processing stage for correlation, integration, and downsampling.

The downsampling operation, step 220, may decrease the data rate while preserving the essential frequency and code-phase characteristics of the signal. In some embodiments, this operation may be performed by the processor 420 or the communication module 490 of the electronic device shown in FIG. 4.

The output of this step may be a downsampled version of the rotated signal, which maintains sufficient structure to support per-hypothesis (i.e., per-frequency offset) phase correction and correlation in the next stages by preserving the code pattern and frequency content within the Nyquist limit.

After the composite rotation, small residual phase differences may remain between the rotated signal and each Doppler frequency hypothesis due to slight mismatches between the actual Doppler shifts and the frequency components of the composite signal. At step 225, the downsampled signal may be subjected to phase correction for each of the Doppler frequency hypotheses. This operation may be performed by the processor 420 or by the communication module 490 of the electronic device shown in FIG. 4. This step compensates for the residual phase differences that remain after the composite rotation and downsampling. While the earlier rotation step used a single composite signal to achieve a coarse frequency alignment across all hypotheses, this phase correction step performs fine (i.e., precise) phase alignment for each specific hypothesis prior to correlation.

For each Doppler frequency hypothesis, the receiver may apply a corresponding phase correction to the downsampled signal. These corrections may be derived based on the residual phase offset associated with each hypothesis. In one example, the correction is performed by multiplying the downsampled signal with a complex exponential corresponding to the residual phase. This complex exponential applies a phase shift to the downsampled signal, aligning it with the phase of the reference code. This operation may be performed at the reduced sampling rate after downsampling, thereby lowering the computational complexity compared to performing per-hypothesis corrections at the full input rate.

The output of this step may be a plurality of phase-corrected signals, one for each Doppler frequency hypothesis. Each signal may now be phase-aligned and prepared for subsequent correlation with the known reference code.

At step 230, each of the phase-corrected signals generated in step 225 may be correlated with the known reference code used in the transmitted signal. This correlation may be performed by the processor 420 or by the communication module 3490 of the electronic device shown in FIG. 4. The correlation may be performed using a time-domain or frequency-domain method, such as multiplying the phase-corrected samples by corresponding reference code samples and accumulating the results over an integration interval. This step enables the receiver to evaluate how well each phase-corrected signal aligns with the expected signal structure, thereby facilitating detection of the received signal r[n] and estimation of its parameters.

The same reference code used in the original transmission may be used here to evaluate the match with each Doppler hypothesis. The correlation process yields a similarity metric, such as a correlation magnitude or energy, for each hypothesis, indicating the likelihood that the corresponding Doppler shift and code phase match those of the incoming signal.

The output of this step may be a set of correlation outputs (i.e., values), one for each Doppler frequency hypothesis. These values are passed to the next step for selection of the best matching hypothesis and final acquisition decision.

In step 235, the receiver may analyze the set of correlation outputs produced in step 230 to determine the most likely parameters of the received signal r[n]. This analysis may be performed by the main processor 421 or the processor 420 of the electronic device shown in FIG. 4. Each correlation output may represent a measure of similarity or alignment between the received signal and the reference code at a given Doppler frequency hypothesis and code phase. The receiver may compute the magnitude or energy of these correlation values and compare them across all hypotheses and code phases to identify the combination that yields the maximum correlation value. The Doppler frequency hypothesis and code phase corresponding to this maximum may be selected as the estimated parameters of the received signal.

This maximum indicates the strongest match between a phase-corrected signal and the known reference code, signifying both the correct Doppler shift and the correct temporal alignment (i.e., code phase) of the received signal r[n]. A correct Doppler shift is one that compensates for the actual frequency offset between the transmitted and received signals, thereby removing the frequency difference caused by relative motion or oscillator mismatch. An incorrect Doppler shift leaves a residual frequency error. A correct temporal alignment may occur when the locally generated reference code is time-aligned with the corresponding code sequence in the received signal. If the alignment is incorrect, the correlation output remains low because the code symbols do not match over the integration window. The Doppler frequency hypothesis associated with this peak corresponds to an estimate of the frequency offset \hat{f}, and the position of the peak within the correlation output yields the estimated code phase \hat{k}.

The outputs of this step are the selected Doppler frequency hypothesis and code phase, which may be used to initialize tracking loops or subsequent demodulation stages. Signal acquisition may be considered successful when the receiver identifies a correlation peak corresponding to a match between the phase-corrected signal and the reference code, indicating that the Doppler frequency and code phase have been correctly estimated. These parameters establish the frequency and timing alignment needed for the receiver to lock onto and decode the received signal r[n].

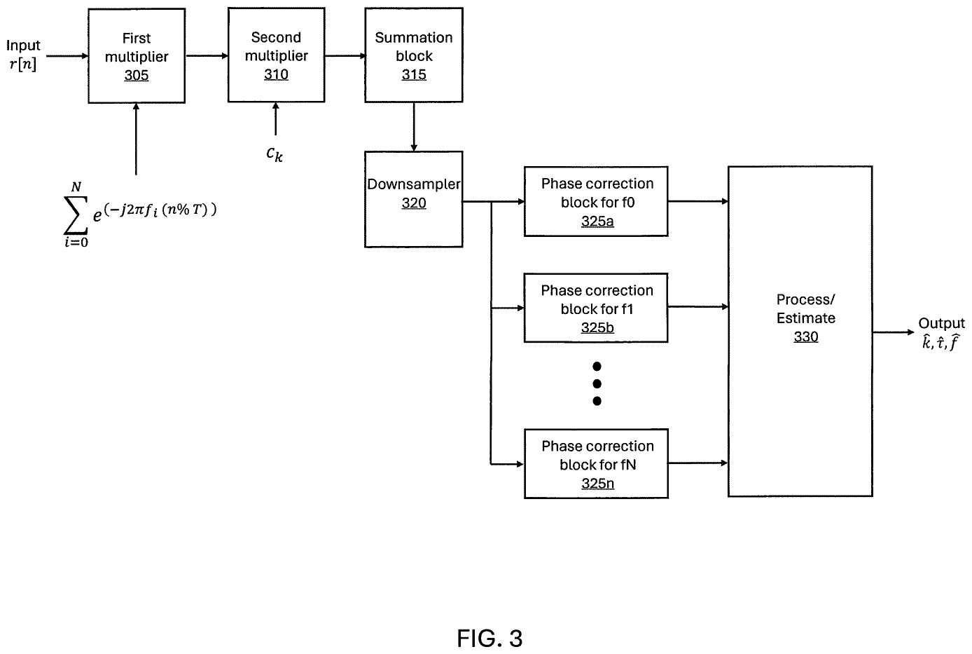

FIG. 3 is a block diagram of a receiver implementing a method of acquiring a signal, according to an embodiment.

The illustrated receiver includes the following components: a first multiplier 305, a second multiplier 310, a summation block 315, a downsampler 320, a bank of phase correction blocks 325a-325n, and a process/estimate block 330. These components may implement the signal acquisition flow shown in FIG. 2.

The received signal r[n], which includes a known reference code affected by Doppler shift and noise, is input to the first multiplier 305. In this stage, the received signal r[n] is multiplied by a composite frequency signal formed by summing complex exponentials corresponding to a plurality of Doppler frequency hypotheses. Specifically, the input to the first multiplier 305 includes a tone summation of the form:

$${\sum }_{i = 0}^{N} {e}^{( - j 2 π {f}_{i} ( n \% T ) )}$$

This summation serves as a composite Doppler rotation signal, which approximates simultaneous frequency shifting across the entire Doppler hypothesis range over a window of length T. T may be expressed in seconds or samples. Here % denotes modulo operation. T is a design parameter and by selecting N there may be a high correlation between e^{(-j2πf}^{ᵢ}^{(n % T))} for i=0:N. The following discussion provides some details about the design parameters of T. SNR of the received signal (r[n]=sₖ[n]·e^{(j2πf}^{ₖ}^{n+φ}^{ₖ}⁾+ w[n]) is

$${SNR}_{r} = 10 \cdot {log}_{10} ( {\vert b \vert}^{2} / {σ}_{w}^{2} ) .$$

Assume K=1, after rotation based on sum of all the hypothesis:

$$r w [ n ] = r [ n ] \cdot {\sum }_{i = 1}^{N} {e}^{( - j 2 π {f}_{i} n )}$$

$$rw [ n ] = {s}_{1} [ n ] \cdot {e}^{j {ϕ}_{1}} + [ {s}_{1} [ n ] \cdot {e}^{( j 2 π {f}_{1} n + j {ϕ}_{1} )} ] {\sum }_{i = 2}^{N} {e}^{( - j 2 π {f}_{i} n )} + w [ n ] \cdot {\sum }_{i = 1}^{N} {e}^{( - j 2 π {f}_{i} n )}$$

The last term is the dominant term. Cross correlations (R_{n,m}(τ)) of two sinusoids is:

$${R}_{n , m} ( τ ) = {\int }_{- ∞}^{∞} {e}^{( j 2 π {f}_{n} t )} \cdot {e}^{( - j 2 π {f}_{m} ( t - τ ) )} dt = {e}^{( - j 2 π {f}_{m} τ )} . {\int }_{- ∞}^{∞} {e}^{( j 2 π ( {f}_{n} - {f}_{m} ) t )} d t = 0$$

This means there are N uncorrelated noise terms, so the SNR will be:

$${SNR}_{r w} = 10 \cdot {log}_{10} ( {\vert b \vert}^{2} / N \cdot {σ}_{w}^{2} ) = {SNR}_{r} - 10 \cdot {log}_{10} ( N )$$

Fᵢ[n] may be defined as

$${F}_{i} [ n ] {=}^{def} {e}^{- j 2 π {f}_{i} n} .$$

If Fᵢ[n] are uncorrelated we have SNR loss:

$$r w [ n ] = ( {s}_{1} [ n ] \cdot {e}^{j ( 2 π {f}_{1} n + {ϕ}_{1} )} + w [ n ] ) \cdot ( {F}_{1} [ n ] + {F}_{2} [ n ] + … + {F}_{N} [ n ] )$$

Since the variance of signal part is

$${σ}_{s}^{2}$$

and variance of noise is N.

$${σ}_{w}^{2} .$$

However, if Fᵢ[n] are highly correlated SNR loss is negligible:

$$r w [ n ] \approx ( {s}_{1} [ n ] \cdot {e}^{j ( 2 π {f}_{1} n + {ϕ}_{1} )} + w [ n ] ) \cdot ( N \cdot {F}_{1} [ n ] )$$

As variance of signal is

$${N}^{2} \cdot {σ}_{s}^{2}$$

and variance of noise is

$${N}^{2} \cdot {σ}_{w}^{2} .$$

Cross correlation between two tones may be defined as

$${R}_{n , m} ( τ ) = {\int }_{- T}^{T} {e}^{( j 2 π {f}_{n} t )} \cdot {e}^{( - j2 π {f}_{m} ( t - τ ) )} dt .$$

There may be high cross correlation when fₙ and fₘ are very close or when T is small number. Therefore, the signal is rotated with a portion of the sinusoids which are highly correlated, as shown by:

$${\sum }_{i = 0}^{N} {e}^{( - j 2 π {f}_{i} ( n \% T ) )}$$

This can cause phase jumps at the rate of T after correlator for each frequency of ﬁ which needs to be compensated. The output of the first multiplier 305 may be a rotated signal, where the Doppler-induced frequency offset has been corrected for all hypotheses in a single full-rate operation.

The rotated signal output from the first multiplier 305 is then passed to the second multiplier 310, where it is multiplied by a code c (also referred to as a reference code). This code c corresponds to the Pseudorandom Noise (PN) sequence assigned to index k, which identifies the transmitter or signal source.

The output of the second multiplier 310 is then processed by the summation block 315, which performs accumulation over an integration interval. In this implementation, the summation occurs every T samples, thereby integrating signal energy and improving the signal-to-noise ratio. The accumulated signal is then sent to the downsampler 320, which reduces the sample rate by a factor aligned with the integration period.

The downsampled signal is then routed to the bank of phase correction blocks 325a-325n, each associated with a respective Doppler frequency hypothesis. Each block applies a fine-grain residual phase correction, compensating for small per-hypothesis phase misalignments that remain after the initial composite rotation.

The outputs of the phase correction blocks 325a-325n are fed into the process/estimate block 330, which performs correlation with the known reference code and identifies the Doppler frequency hypothesis and code phase that produce the highest correlation response. The outputs of this block include the selected Doppler frequency hypothesis f and the estimated code phase k, which mark the completion of the acquisition process.

Each of the blocks in FIG. 3 may be implemented using hardware or software. The first and second multipliers 305 and 310 may be realized using complex multiplier logic. The summation block 315 may use an accumulator with modulo control logic. The downsampler 320 may use decimation or clock control mechanisms. The phase correction blocks 325a-325n may include low-rate complex multipliers, and the process/estimate block 330 may include correlation engines, buffers, and peak detection logic.

In some embodiments, the method and receiver described in FIGS. 2 and 3 may be integrated into other signal acquisition strategies to further enhance detection performance and Doppler resolution.

In one example, the method (using high-correlated rotators for multiple Doppler frequency hypotheses) is employed to perform a coarse frequency search across a limited set of N hypotheses. Once the most likely Doppler region is identified, an FFT-based technique may be applied within that region to perform fine frequency resolution. This hybrid coarse/fine search allows rapid acquisition over large Doppler spreads with reduced processing.

In another example, the entire Doppler range is covered using only the high-correlated rotators. This approach allows the receiver to scan a broad frequency space using the composite-rotation-based method without relying on FFT-base refinement. For comparison with typical FFT-based techniques, assume the FFT has M points and p represents the effective number of subcarriers used. The total Doppler span in the rotator-only method can then be defined as (p×M)×N, where N is the number of base (coarse) frequency hypotheses. This full-range coverage enables consistent acquisition performance across a wide Doppler space without requiring transition to FFT-based stages.

FIG. 4 is a block diagram of an electronic device in a network environment 400, according to an embodiment.

Referring to FIG. 4, an electronic device 401 in a network environment 400 may communicate with an electronic device 402 via a first network 498 (e.g., a short-range wireless communication network), or an electronic device 404 or a server 408 via a second network 499 (e.g., a long-range wireless communication network). The electronic device 401 may communicate with the electronic device 404 via the server 408. The electronic device 401 may include a processor 420, a memory 440, an input device 450, a sound output device 455, a display device 460, an audio module 470, a sensor module 476, an interface 477, a haptic module 479, a camera module 480, a power management module 488, a battery 489, a communication module 490, a subscriber identification module (SIM) card 496, or an antenna module 497. In one embodiment, at least one (e.g., the display device 460 or the camera module 480) of the components may be omitted from the electronic device 401, or one or more other components may be added to the electronic device 401. Some of the components may be implemented as a single integrated circuit (IC). For example, the sensor module 476 (e.g., a fingerprint sensor, an iris sensor, or an illuminance sensor) may be embedded in the display device 460 (e.g., a display).

The processor 420 may execute software (e.g., a program 440) to control at least one other component (e.g., a hardware or a software component) of the electronic device 401 coupled with the processor 420 and may perform various data processing or computations.

As at least part of the data processing or computations, the processor 420 may load a command or data received from another component (e.g., the sensor module 476 or the communication module 490) in volatile memory 432, process the command or the data stored in the volatile memory 432, and store resulting data in non-volatile memory 434. The processor 420 may include a main processor 421 (e.g., a central processing unit (CPU) or an application processor (AP)), and an auxiliary processor 423 (e.g., a graphics processing unit (GPU), an image signal processor (ISP), a sensor hub processor, or a communication processor (CP)) that is operable independently from, or in conjunction with, the main processor 421. Additionally, or alternatively, the auxiliary processor 423 may be adapted to consume less power than the main processor 421, or execute a particular function. The auxiliary processor 423 may be implemented as being separate from, or a part of, the main processor 421.

The auxiliary processor 423 may control at least some of the functions or states related to at least one component (e.g., the display device 460, the sensor module 476, or the communication module 490) among the components of the electronic device 401, instead of the main processor 421 while the main processor 421 is in an inactive (e.g., sleep) state, or together with the main processor 421 while the main processor 421 is in an active state (e.g., executing an application). The auxiliary processor 423 (e.g., an image signal processor or a communication processor) may be implemented as part of another component (e.g., the camera module 480 or the communication module 490) functionally related to the auxiliary processor 423.

The processor 420, including its main processor 421 and/or auxiliary processor 423, may be configured to perform one or more signal processing operations, including the method for acquiring a signal using composite frequency rotation, downsampling, and per-hypothesis phase correction as described herein. In some embodiments, these operations may instead be implemented, in whole or in part, by the communication module 490, which may function as a receiver.

The memory 430 may store various data used by at least one component (e.g., the processor 420 or the sensor module 476) of the electronic device 401. The various data may include, for example, software (e.g., the program 440) and input data or output data for a command related thereto. The memory 430 may include the volatile memory 432 or the non-volatile memory 434. Non-volatile memory 434 may include internal memory 436 and/or external memory 438.

The program 440 may be stored in the memory 430 as software, and may include, for example, an operating system (OS) 442, middleware 444, or an application 446.

The input device 450 may receive a command or data to be used by another component (e.g., the processor 420) of the electronic device 401, from the outside (e.g., a user) of the electronic device 401. The input device 450 may include, for example, a microphone, a mouse, or a keyboard.

The sound output device 455 may output sound signals to the outside of the electronic device 401. The sound output device 455 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 460 may visually provide information to the outside (e.g., a user) of the electronic device 401. The display device 460 may include, for example, a display, a hologram device, or a projector and control circuitry to control a corresponding one of the display, hologram device, and projector. The display device 460 may include touch circuitry adapted to detect a touch, or sensor circuitry (e.g., a pressure sensor) adapted to measure the intensity of force incurred by the touch.

The audio module 470 may convert a sound into an electrical signal and vice versa. The audio module 470 may obtain the sound via the input device 450 or output the sound via the sound output device 455 or a headphone of an external electronic device 402 directly (e.g., wired) or wirelessly coupled with the electronic device 401.

The sensor module 476 may detect an operational state (e.g., power or temperature) of the electronic device 401 or an environmental state (e.g., a state of a user) external to the electronic device 401, and then generate an electrical signal or data value corresponding to the detected state. The sensor module 476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 477 may support one or more specified protocols to be used for the electronic device 401 to be coupled with the external electronic device 402 directly (e.g., wired) or wirelessly. The interface 477 may include, for example, a high-definition multimedia interface (HDMI), a universal serial bus (USB) interface, a secure digital (SD) card interface, or an audio interface.

A connecting terminal 478 may include a connector via which the electronic device 401 may be physically connected with the external electronic device 402. The connecting terminal 478 may include, for example, an HDMI connector, a USB connector, an SD card connector, or an audio connector (e.g., a headphone connector).

The haptic module 479 may convert an electrical signal into a mechanical stimulus (e.g., a vibration or a movement) or an electrical stimulus which may be recognized by a user via tactile sensation or kinesthetic sensation. The haptic module 479 may include, for example, a motor, a piezoelectric element, or an electrical stimulator.

The camera module 480 may capture a still image or moving images. The camera module 480 may include one or more lenses, image sensors, image signal processors, or flashes. The power management module 488 may manage power supplied to the electronic device 401. The power management module 488 may be implemented as at least part of, for example, a power management integrated circuit (PMIC).

The battery 489 may supply power to at least one component of the electronic device 401. The battery 489 may include, for example, a primary cell which is not rechargeable, a secondary cell which is rechargeable, or a fuel cell.

The communication module 490 may support establishing a direct (e.g., wired) communication channel or a wireless communication channel between the electronic device 401 and the external electronic device (e.g., the electronic device 402, the electronic device 404, or the server 408) and performing communication via the established communication channel. The communication module 490 may include one or more communication processors that are operable independently from the processor 420 (e.g., the AP) and supports a direct (e.g., wired) communication or a wireless communication. The communication module 490 may include a wireless communication module 492 (e.g., a cellular communication module, a short-range wireless communication module, or a global navigation satellite system (GNSS) communication module) or a wired communication module 494 (e.g., a local area network (LAN) communication module or a power line communication (PLC) module). A corresponding one of these communication modules may communicate with the external electronic device via the first network 498 (e.g., a short-range communication network, such as BLUETOOTH™, wireless-fidelity (Wi-Fi) direct, or a standard of the Infrared Data Association (IrDA)) or the second network 499 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 492 may identify and authenticate the electronic device 401 in a communication network, such as the first network 498 or the second network 499, using subscriber information (e.g., international mobile subscriber identity (IMSI)) stored in the subscriber identification module 496.

The antenna module 497 may transmit or receive a signal or power to or from the outside (e.g., the external electronic device) of the electronic device 401. The antenna module 497 may include one or more antennas, and, therefrom, at least one antenna appropriate for a communication scheme used in the communication network, such as the first network 498 or the second network 499, may be selected, for example, by the communication module 490 (e.g., the wireless communication module 492). The signal or the power may then be transmitted or received between the communication module 490 and the external electronic device via the selected at least one antenna.

Commands or data may be transmitted or received between the electronic device 401 and the external electronic device 404 via the server 408 coupled with the second network 499. Each of the electronic devices 402 and 404 may be a device of a same type as, or a different type, from the electronic device 401. All or some of operations to be executed at the electronic device 401 may be executed at one or more of the external electronic devices 402, 404, or 408. For example, if the electronic device 401 should perform a function or a service automatically, or in response to a request from a user or another device, the electronic device 401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 401. The electronic device 401 may provide the outcome, with or without further processing of the outcome, as at least part of a reply to the request. To that end, a cloud computing, distributed computing, or client-server computing technology may be used, for example.

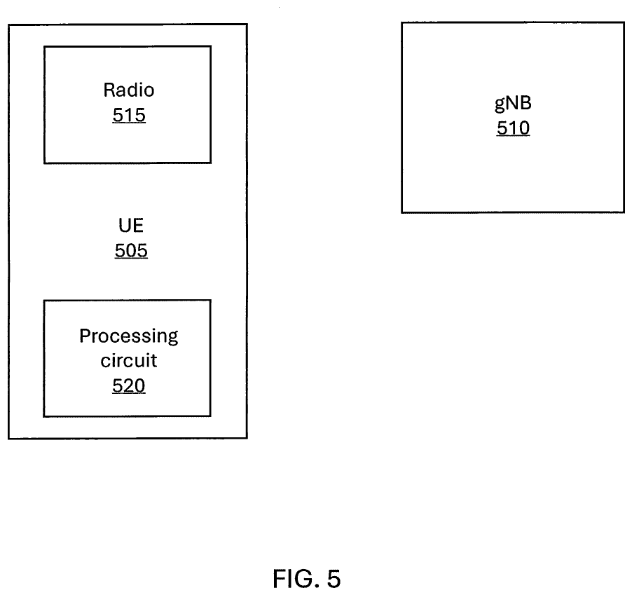

FIG. 5 shows a system including a UE 505 and a gNB 510, in communication with each other. The UE may include a radio 515 and a processing circuit (or a means for processing) 520, which may perform various methods disclosed herein, e.g., the method illustrated in FIG. 1. For example, the processing circuit 520 may receive, via the radio 515, transmissions from the network node (gNB) 510, and the processing circuit 520 may transmit, via the radio 515, signals to the gNB 510.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method of acquiring a signal in a receiver, the method comprising:
receiving a signal including a reference code;
generating a plurality of frequency hypotheses across a Doppler frequency range associated with the signal;
rotating the signal using a composite signal formed by summing time sections of sinusoidal tones corresponding to the plurality of frequency hypotheses;
downsampling the rotated signal;
applying a respective phase correction to the downsampled signal for each of the plurality of frequency hypotheses to produce a plurality of phase-corrected signals;
correlating each phase-corrected signal with the reference code to detect the signal that includes the reference code and generate a plurality of correlation outputs; and
selecting a frequency hypothesis of the plurality of frequency hypotheses and a code phase based on a maximum value among the correlation outputs.

2. The method of claim 1, wherein each tone corresponds to a sinusoid having a frequency equal to a respective one of the plurality of frequency hypotheses.

3. The method of claim 1, wherein rotating the signal comprises multiplying the received signal with the composite signal.

4. The method of claim 1, wherein the composite signal is precomputed and stored prior to rotating the signal.

5. The method of claim 1, wherein each phase correction comprises multiplying the downsampled signal by an exponential corresponding to a respective one of the plurality of frequency hypotheses.

6. The method of claim 1, wherein the same downsampled signal is subjected to different phase corrections to generate the plurality of phase-corrected signals.

7. The method of claim 1, wherein the respective phase corrections are applied at a lower sampling rate than rotating the signal.

8. The method of claim 1, wherein the signal that includes the reference code is a satellite positioning signal.

9. The method of claim 1, wherein the reference code comprises a pseudorandom noise (PN) sequence, or a Zadoff-Chu sequence.

10. A user equipment (UE) comprising:
a processor; and
a non-transitory computer readable storage medium storing instructions that, when executed, cause the processor to:
receive a signal including a reference code;
generate a plurality of frequency hypotheses across a Doppler frequency range associated with the signal;
rotate the signal using a composite signal formed by summing time sections of sinusoidal tones corresponding to the plurality of frequency hypotheses;
downsample the rotated signal;
apply a respective phase correction to the downsampled signal for each of the plurality of frequency hypotheses to produce a plurality of phase-corrected signals;
correlate each phase-corrected signal with the reference code to detect the signal that includes the reference code and generate a plurality of correlation outputs; and
select a frequency hypothesis of the plurality of frequency hypotheses and a code phase based on a maximum value among the correlation outputs.

11. The UE of claim 10, wherein each tone corresponds to a sinusoid having a frequency equal to a respective one of the plurality of frequency hypotheses.

12. The UE of claim 10, wherein, in rotating the signal, the instructions further cause the processor to multiply the signal with the composite signal.

13. The UE of claim 10, wherein the composite signal is precomputed and stored prior to rotating the signal.

14. The UE of claim 10, wherein, in applying a respective phase correction to the downsampled signal, for each phase correction, the instructions further cause the processor to multiply the downsampled signal by an exponential corresponding to a respective one of the plurality of frequency hypotheses.

15. The UE of claim 10, wherein the same downsampled signal is subjected to different phase corrections to generate the plurality of phase-corrected signals.

16. The UE of claim 10, wherein the respective phase corrections are applied at a lower sampling rate than rotating the signal.

17. The UE of claim 10, wherein the signal that includes the reference code is a satellite positioning signal.

18. The UE of claim 10, wherein the reference code comprises a pseudorandom noise (PN) sequence, or a Zadoff-Chu sequence.

19. A method of acquiring a signal in a receiver, comprising:
rotating a received signal using a composite signal based on a plurality of Doppler frequency hypotheses;
applying a respective phase correction to the rotated signal for each of the plurality of Doppler frequency hypotheses to generate a plurality of phase-corrected signals; and
determining a Doppler frequency hypothesis associated with the received signal based on the phase-corrected signals.

20. The method of claim 19, wherein the composite signal is formed by summing tones corresponding to the plurality of Doppler frequency hypotheses.
